(19) United States
(12) Patent Application Publication
(10) Pub. No.: US 2019/0237821 A1
(43) Pub. Date: Aug. 1, 2019

(54) Low temperature engine start method for smart battery

(71) Applicant: Kwun Hing Lo, Hong Kong (CN)

(72) Inventor: Kwun Hing Lo, Hong Kong (CN)

(21) Appl. No.: 16/381,016

(22) Filed: Apr. 11, 2019

(51) Int. Cl. H01M 10/42; H01M 10/6555; H01M 2/10; H01M 10/615; H01M 10/625; H01M 10/44; H02J 7/00; F02N 11/08

(52) U.S. Cl. CPC H01M 10/4257; H01M 10/6555; H01M 2/1077; H01M 10/615; H01M 2220/20; H01M 10/44; H02J 7/0063; H02J 7/007; F02N 11/0862; H01M 10/625

(57) ABSTRACT

A power supply method of starting an engine in a low temperature environment for a smart battery system including an outer casing, an upper cover disposed above the outer casing, and a body disposed inside the outer casing. The method includes the temperature of the main battery module of the smart battery system is within the system default operating temperature range of the system battery, the stored power of the main battery module is higher than the default power storage value of the main battery used to start the engine, the user can directly operate or control the start power switch of the vehicle, the ship or the mechanical equipment, and the main battery module of the smart battery system can provide the power output to the power supply circuit of the battery system connected with the vehicle, ship or mechanical equipment, so as to start the engine.

### BACKGROUND OF THE INVENTION

### 1. Field of the Invention

The invention relates to smart battery systems and more particularly to a power supply method of starting an engine in a low temperature environment for a smart battery system.

### 2. Description of Related Art

The general battery system is used to start the engine, so as to start the vehicle, ship or mechanical equipment connected with the battery system, and to assist in providing the power to the device connected with the power supply circuit; however, the traditional battery system can not be properly operated in the low temperature environment, and the standby power supply circuit is not disposed to provide the power for starting the engine immediately when the main battery of the system is exhausted; therefore, the traditional battery system still has a lot of space for improvement in actual use.

### SUMMARY OF THE INVENTION

It is therefore one object of the invention to provide a power supply method of starting an engine in a low temperature environment for a smart battery system including an outer casing, an upper cover disposed above the outer casing, and a body disposed inside the outer casing, comprising the steps of the temperature of the main battery module of the smart battery system is within the system default operating temperature range of the system battery and the stored power of the main battery module is higher than the default power storage value of the main battery used to start the engine; the user can directly operate or control the start power switch of the vehicle, the ship or the mechanical equipment, and the main battery module of the smart battery system can provide the power output to the power supply circuit of the battery system connected with the vehicle, ship or mechanical equipment, so as to start the engine; the temperature of the main battery module of the smart battery system is lower than the system default operating temperature range of the system battery, or the temperature of the main battery module is within the system default operating temperature range of the system battery, and the stored power of the main battery module is lower than the system default power storage value of the main battery for starting the engine; the main battery module of the smart battery system cannot start the engine of the power supply circuit of the vehicle, the ship or the mechanical equipment electrically connected with the smart battery system, and the user can remotely control and set the smart battery system by the handheld control device, so that the system can enter the standby power supply mode to start the engine, or the user can control the setting of the smart battery system by directly pressing down the start switch of the upper cover of the smart battery system for setting the standby power supply mode of the smart battery system; the standby power supply mode includes the temperature of the high power battery module is within a system default operating temperature range of the system battery, and the stored power of the high power battery module is higher than that of the high power battery for starting the engine; then the high power battery module can provide the power output to the power supply circuit connected with the vehicle, the ship or mechanical equipment via the battery system, so as to start the engine; the temperature of the high power battery module is within the system default operating temperature range of the system battery, and the stored power of the high power battery module is lower than the system default power storage value of the high power battery power for starting the engine; then the low temperature battery module can provide power output to the high power battery module via the battery system power supply circuit, thereby charging the high power battery module; when the stored power of the high power battery module is increased to be higher than the system default power storage value of the high power battery for starting the engine; then the high power battery module can provide the power output to the power supply circuit connected with the vehicle, ship or mechanical equipment battery via the battery system power supply circuit for starting the engine; the temperature of the high power battery module is lower than the system default battery operating temperature range, and the temperature of the low temperature battery module is within the system default temperature range and higher than the heating start temperature of the low temperature battery; then the low temperature battery module can provide the power output to the heating plates of the high power battery module via the battery system power supply circuit, thereby heating the high power battery module; after the temperature of the high power battery module is heated to the system default temperature range of the system battery and the stored power of the high power battery module is lower than the system default power storage value of the high power battery for starting the engine; then the low temperature battery module can further provide the power output to the high power battery module via the battery system power supply circuit, thereby charging the high power battery module; after the stored power of the high power battery module is increased to be higher than the system default storage value of the high power battery power for starting the engine; then the high power battery module can provide the power output to the power supply circuit connected with the vehicle, the ship or the mechanical equipment via the battery system power supply circuit in a low temperature environment, so as to start the engine; the temperature of the high power battery module is lower than the system default battery operating temperature range and the temperature of the low temperature battery module is within the system default operating temperature range of the low temperature battery but lower than the heating start temperature of the low temperature battery; then the low temperature battery module can provide the power output to the heating plate of the low temperature battery module via the battery system power supply circuit, thereby heating the low temperature battery module; after the temperature of the low temperature battery module is heated to be higher than the system default heating start temperature of the low temperature battery; then the low temperature battery module can further provide the power output to the circuit plates of the high power battery module via the battery system power supply circuit, thereby heating the high power battery module; after the temperature of the high power battery module is heated to be within the system default operating temperature range of the system battery and the stored power of the high power battery module is higher than the system default power storage value of the high power battery for starting the engine; then the high power battery module can provide the power output to the power supply circuit connected with vehicle, the ship or the mechanical equipment via the battery system power supply circuit in a low temperature environment, so as to start the engine; the temperature of the high power battery module is lower than the system default battery operating temperature range and the temperature of the low temperature battery module is within the system default operating temperature range of the low temperature battery but lower than the heating start temperature of the low temperature battery; then the low temperature battery module can provide the power output to the heating plate of the low temperature battery module via the battery system power supply circuit, thereby heating the low temperature battery module; after the temperature of the low temperature battery module is heated to be higher than the system default heating start temperature of the low temperature battery; then the low temperature battery module can further provide the power output to the heating plates of the high power battery module via the battery system power supply circuit, thereby heating the high power battery module; after the temperature of the high power battery module is heated to be within the system default battery operating temperature range and the stored power of the high power battery module is lower than the system default power storage value of the high power battery for starting the engine; then the low temperature battery module can further provide the power output to the high power battery module via the battery system power supply circuit, thereby charging the high power battery module; after the stored power of the high power battery module is increased to be higher than the system default power storage value of the high power battery for starting the engine; then the high power battery module can provide the power output to the power supply circuit connected with vehicle, the ship or the mechanical equipment via the battery system power supply circuit in a low temperature environment, so as to start the engine; and the temperature of the low temperature battery module is lower than the system default operating temperature range of the low temperature battery; then the smart battery system does not work.

The above and other objects, features and advantages of the invention will become apparent from the following detailed description taken with the accompanying drawings.

### BRIEF DESCRIPTION OF THE DRAWINGS

FIG. 1 is a combined view of upper cover, outer casing and body (1) of a smart battery system according to the invention;

FIG. 2 is a combined view of upper cover, outer casing and body (2);

FIG. 3 is an exploded view of outer casing, body combination structure and upper cover;

FIG. 4 is an exploded view of body;

FIG. 5 is an exploded view of main battery module, high power battery module, low temperature battery module, heating plate, thermal insulation layer combination structure and outer casing;

FIG. 6 is a combined view of main battery module, high power battery module and low temperature battery module;

FIG. 7 is a perspective view of heating plate;

FIG. 8 is a combined view of main battery module, high power battery module, low temperature battery module and heating plate; and

FIG. 9 is a combined view of main battery module, high power battery module, low temperature battery module, heating plate and thermal insulation layer.

### DETAILED DESCRIPTION OF THE INVENTION

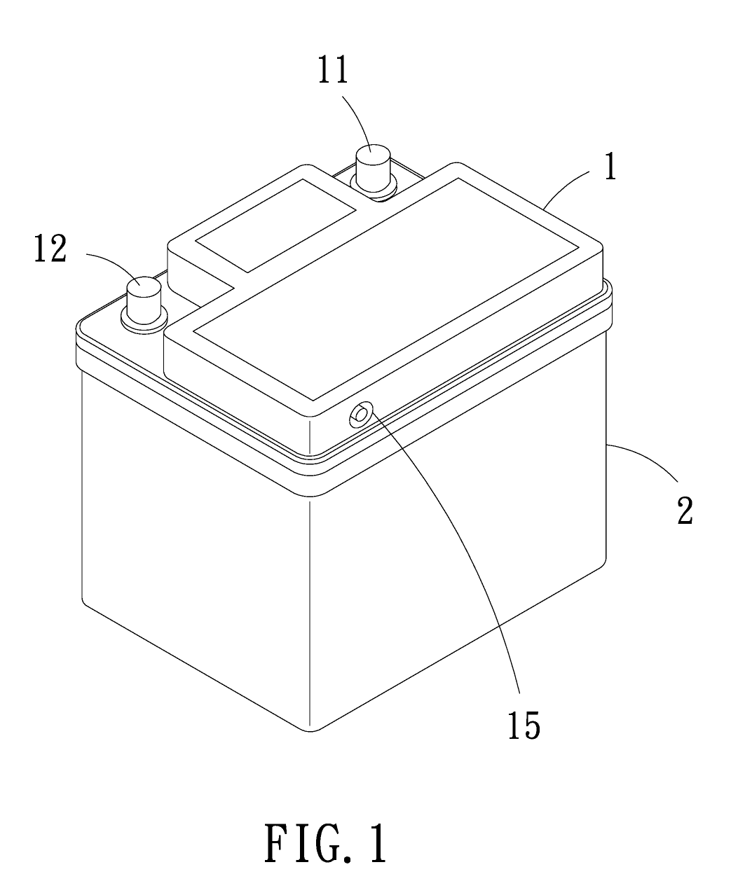

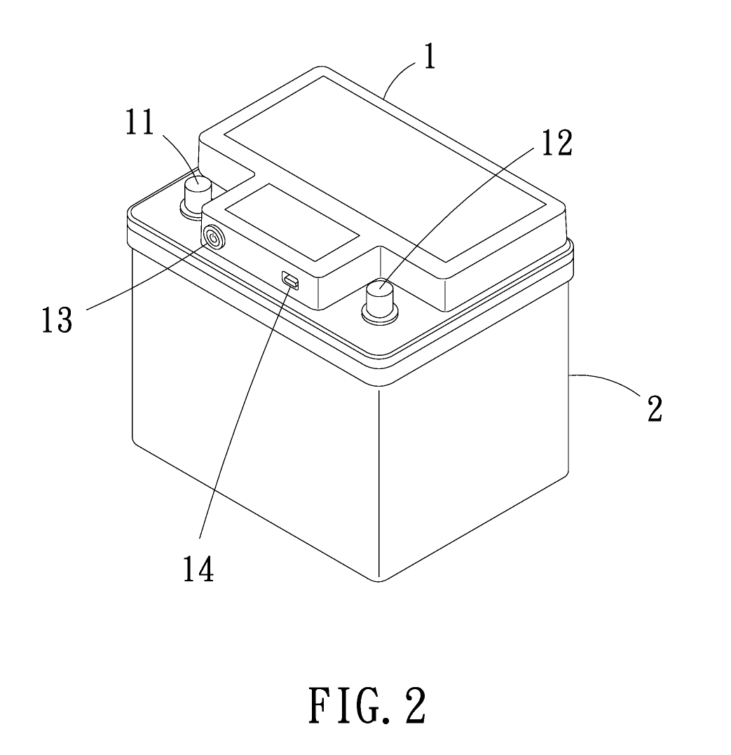

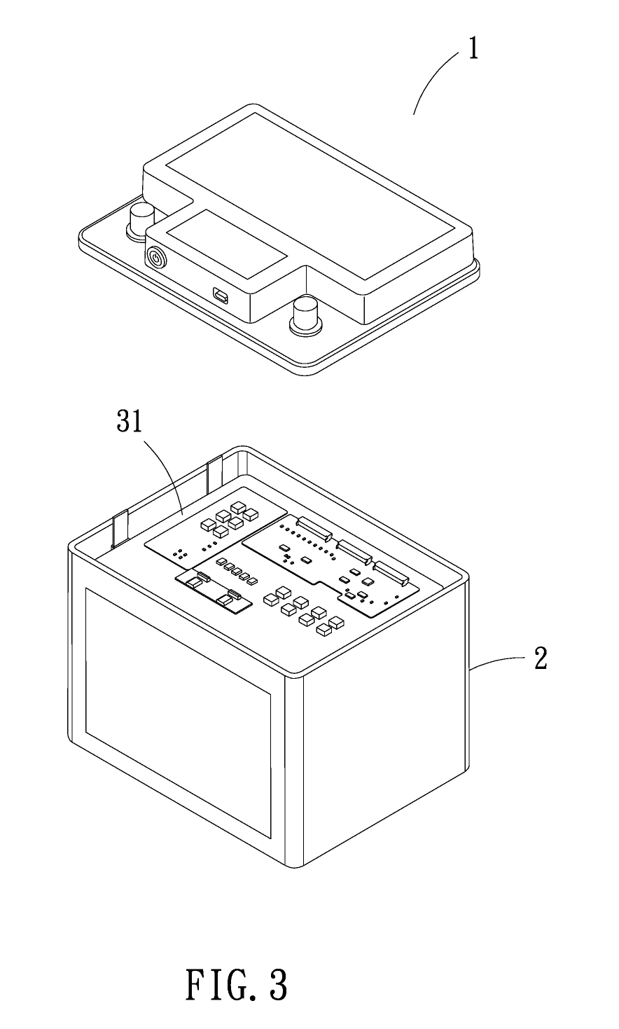

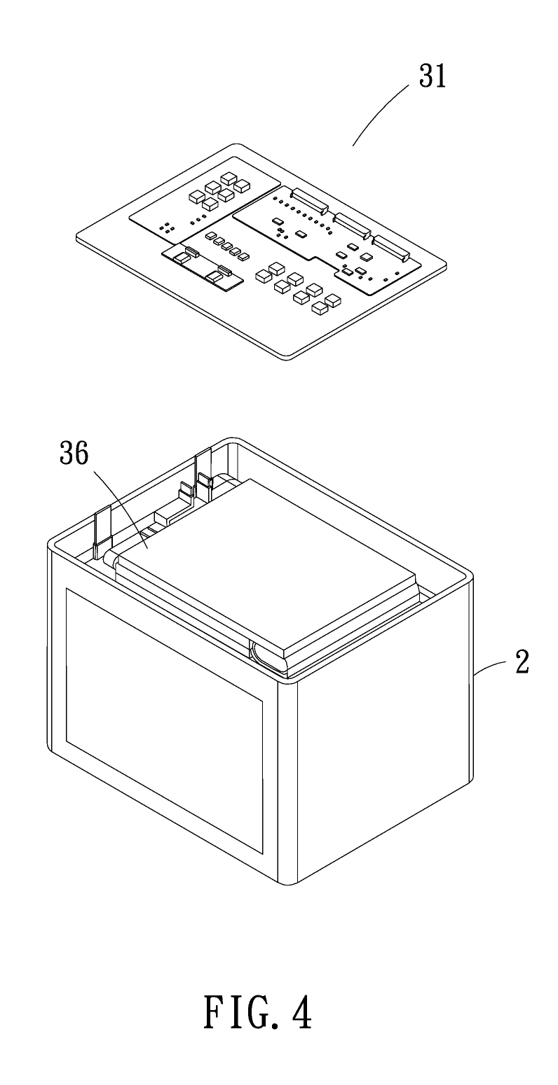

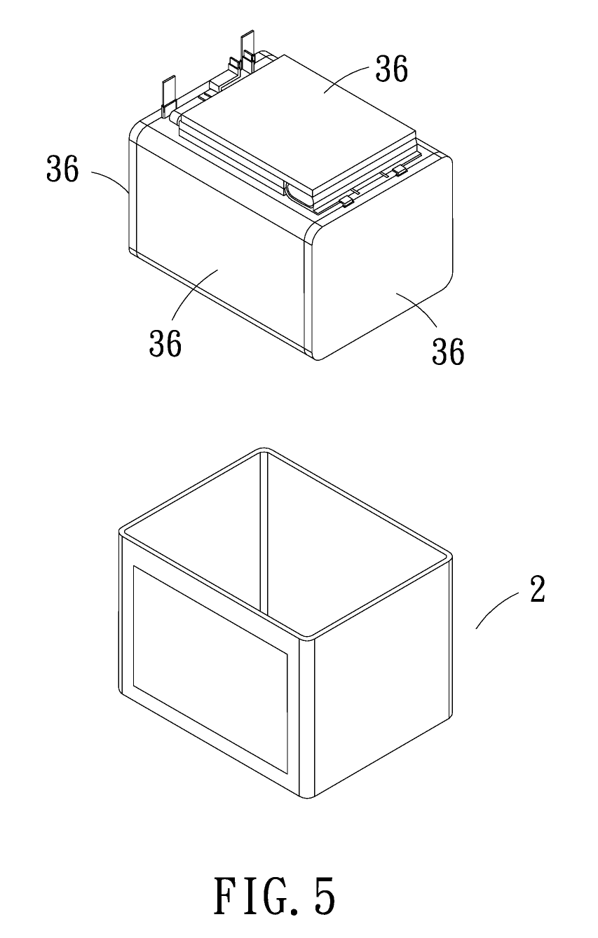

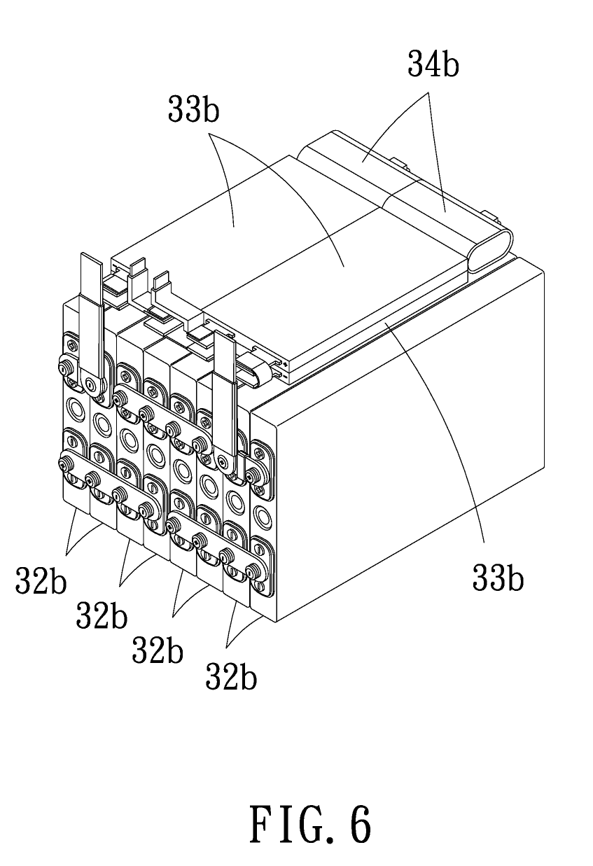

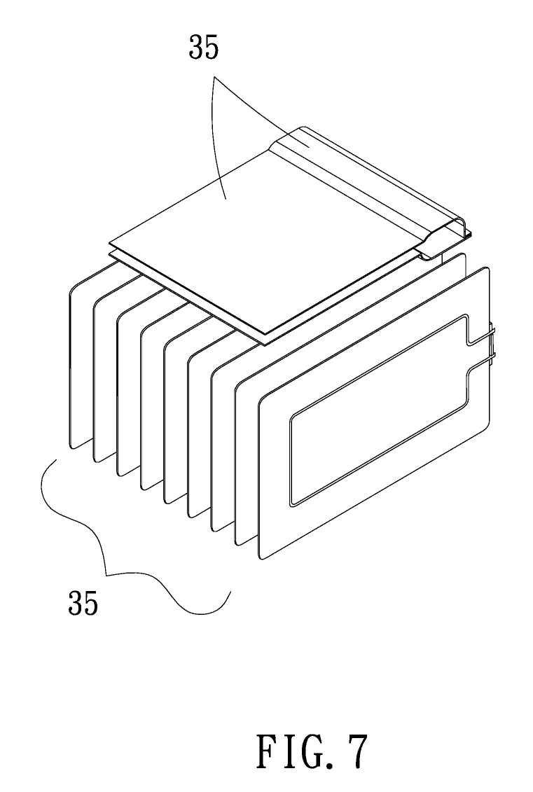

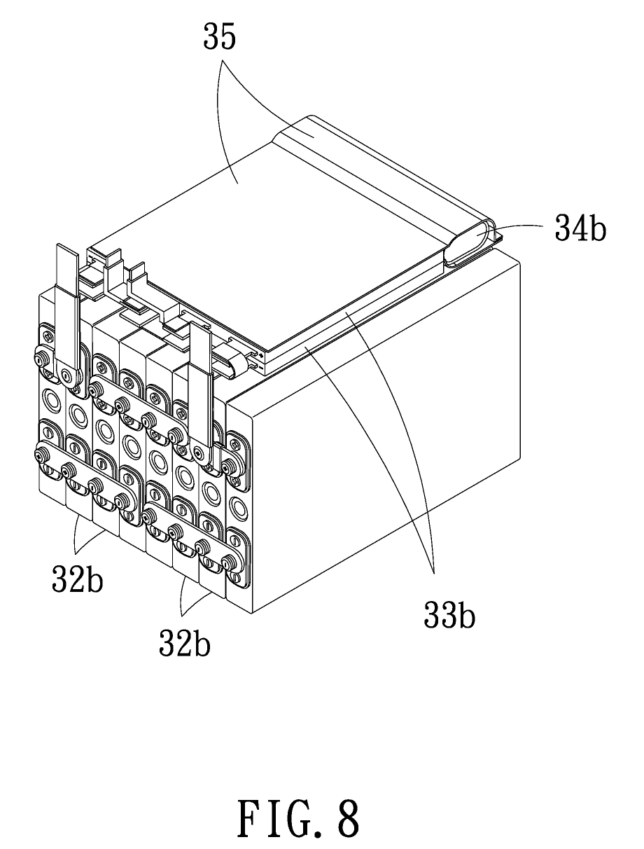

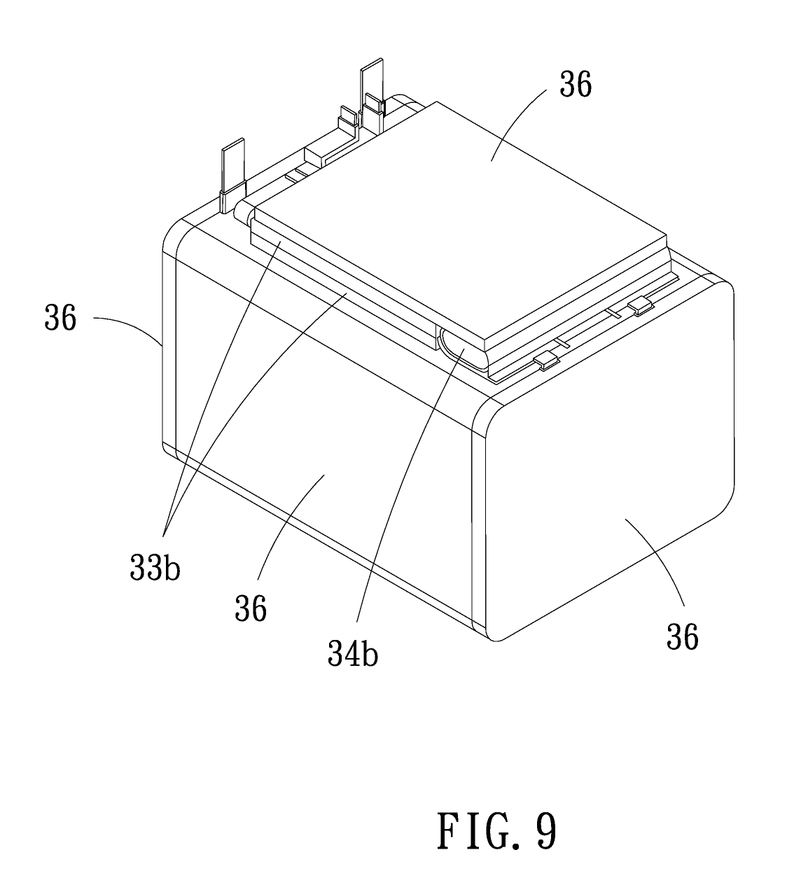

Embodiment 1, please refer to FIG. 1 to FIG. 9, a smart battery system of the invention that can be used for starting the engine in the low temperature, comprises upper cover 1, outer casing 2, body and handheld control device; the handheld control device is provided with wireless transmission module; the body is disposed inside the outer casing 2, and the upper cover 1 is disposed above the outer casing 2. The upper cover 1 is provided with a positive connection terminal 11, a negative connection terminal 12, a start switch 13, a data port 14 and a DC voltage input port 15. The body includes system base plate 31, main battery module, high power battery module, low temperature battery module and a plurality of heating plates 35; the system base plate 31 is provided with a wireless transmission module; wherein, the heating plate 35 is disposed around the high power battery module and the low temperature battery module, and the outside of the heating plate 35 is cover-provided with a thermal insulation layer 36. The handheld control device and the system base plate 31 of the body are in a wireless transmission manner for data transmission and system control setting.

The main battery module includes a plurality of battery blocks 32b and a temperature sensor; the battery blocks 32b are electrically connected to each other, and the temperature sensor is disposed in the battery block 32b; wherein, the heating plates 35 of the body part are respectively disposed at a position between the battery blocks 32b adjacent to each other; a thermal power layer 36 is disposed around the high power battery module. The high power battery module includes a plurality of high power batteries 33b and a temperature sensor; the high power batteries 33b are electrically connected to each other. The temperature sensor is disposed on the high power battery 33b. The low temperature battery module includes a plurality of low temperature batteries 34b and at least one temperature sensor; the low temperature batteries 34b are electrically connected to each other, and the temperature sensor is disposed on the low temperature battery 34b.

The positive connection terminal 11 of the upper cover 1, the negative connection terminal 12 and the DC voltage input port 15 and the main battery module of the body, the high power battery module and the low temperature battery module are electrically connected to each other, to form the battery system power supply circuit. The system base plate 31 of the body and the power supply of the heating plate 35 are electrically connected to the battery system power supply circuit respectively; wherein, the power supply of the system base plate 31 of the body is supplied by the low temperature battery module in the battery system power supply circuit.

The start switch 13 and the data port 14 of the upper cover 1 are electrically connected to the system base plate 31 of the body; the main battery module of the body, the high power battery module and the temperature sensor of the low temperature battery module are electrically connected to the system base plate 31 of the body respectively; and the control circuits of the heating plate 35 of the body are respectively electrically connected to the system base plate 31 of the body; the main battery module of the body, the high power battery module and the control circuit of the low temperature battery module are respectively electrically connected to the system base plate 31.

The thermal insulation layer 36 is a soft structure with heat insulation and insulation properties; the thermal insulation layer 36 is mainly used for blocking the dissipation or conduction of temperature to avoid that the main battery module of the body, the high power battery module and the low temperature battery module are affected by the low temperature of the external environment, and it has the effect of isolating the electrical connection to avoid the short circuit caused by the electric leakage, thereby causing damage to the battery and providing protection for buffer and shockproof. Wherein, the thermal insulation layer 36 is made of silica gel.

When the smart battery system is in use, a connection of the line is required to electrically connect the positive connection terminal 11 of the upper cover 1 and the negative connection terminal 12 to a power supply circuit of a vehicle, a ship or a mechanical equipment, so as to start the engine or to supply the power to the device and equipment connected in the power supply circuit.

The battery block 32b of the main battery module of the body is a battery structure capable of generating an instantaneous high current pulse, and the main battery module is mainly used to start the engine by an instantaneous high current pulse in a normal state, so as to start the a vehicle, ship or mechanical equipment connected with the smart battery system; or supply the power to a device and equipment connected in the power supply circuit. The high power battery 33b of the high power battery module is a battery structure capable of generating an instantaneous high current pulse and a high battery capacity, and the high power battery module is mainly used as a standby power to start the vehicle, ship or mechanical equipment connected with the smart battery system by an instantaneous high current pulse when the main battery module is exhausted. The low temperature battery 34b of the low temperature battery module is a battery structure that can be used in a low temperature environment, and the low temperature battery module is mainly used as standby power for providing the power to the heating plate 35 when the ambient temperature is at a low temperature, or the power is used to charge the high power battery module. Wherein, the battery block 32b of the main battery module adopts a lithium iron phosphate battery; the high power battery 33b of the high power battery module adopts a high current discharge type lithium polymer battery, and the low temperature battery 34b of the low temperature battery module adopts a low temperature power type lithium battery.

The system base plate 31 of the body can detect the temperature of the battery block 32b of the main battery module, the temperature of the high power battery 33b of the high power battery module, the temperature of the low temperature battery 34b of the low temperature battery module in real time through the temperature sensors of the main battery module, the high power battery module and the low temperature battery module, to confirm whether the main battery module, the high power battery module and the low temperature battery module are in an operating temperature range that can be normally charged and discharged, so as to decide whether to start the heating plate 35 for heating the battery blocks 32b of the main battery module, the high power battery 33b of the high power battery module or the low temperature battery 34b of the low temperature battery module.

The user can connect the indoor externally-stable external power supply circuit to the battery system power supply circuit of the smart battery system through the DC voltage input port 15 of the upper cover 1 by using the connection of the external transformer, and then directly charge the main battery module, the high power battery module and the low temperature battery module.

The user presses down the start switch 13 of the upper cover 1, and the system base plate 31 of the body for directly controlling the setting of the high power battery module to generate an instantaneous high current pulse, so as to start the engine of the vehicle, ship or mechanical equipment connected with the smart battery system.

The user or device maintenance personnel can use an external data transmission line to connect the external computer, the test instrument or the inspection device to the system base plate 31 of the body through the data port 14 of the upper cover 1, so as to read and view the system parameters and data of the smart battery system or perform the related control settings and parameter adjustment of the smart battery system.

The user can also remotely connect the system base plate 31 of the body by the handheld control device for control setting, and then can view the system parameters and data of the smart battery system or control settings through the handheld control device. The high power battery module generates an instantaneous high current pulse to start the engine of the vehicle, ship or mechanical equipment connected with the smart battery system.

A power supply method for the smart battery system to start the engine in the low temperature is applied to the smart battery system; the power supply method of the smart battery system includes the temperature of the main battery module of the smart battery system is within the system default operating temperature range of the system battery and the stored power of the main battery module is higher than the default power storage value of the main battery used to start the engine. The user can directly operate or control the start power switch of the vehicle, the ship or the mechanical equipment, and the main battery module of the smart battery system can provide the power output to the power supply circuit of the battery system connected with the vehicle, ship or mechanical equipment, so as to start the engine.

The temperature of the main battery module of the smart battery system is lower than the system default operating temperature range of the system battery, or the temperature of the main battery module is within the system default operating temperature range of the system battery, and the stored power of the main battery module is lower than the system default power storage value of the main battery for starting the engine; the main battery module of the smart battery system cannot start the engine of the power supply circuit of the vehicle, the ship or the mechanical equipment electrically connected with the smart battery system, and the user can remotely control and set the smart battery system by the handheld control device, so that the system can enter the standby power supply mode to start the engine, or the user can control the setting of the smart battery system by directly pressing down the start switch 13 of the upper cover 1 of the smart battery system for setting the standby power supply mode of the smart battery system.

The user can electrically connect the external stable power supply circuit to the battery system power supply circuit via the DC voltage input port 15 of the upper cover 1 of the smart battery system by using the external transformer; the smart battery system will enter the external circuit charging mode, so as to directly charge the main battery module, the high power battery module and the low temperature battery module by using an indoor stable external power supply circuit.

The standby power supply mode includes the temperature of the high power battery module is within a system default operating temperature range of the system battery, and the stored power of the high power battery module is higher than that of the high power battery for starting the engine; then the high power battery module can provide the power output to the power supply circuit connected with the vehicle, the ship or mechanical equipment via the battery system, so as to start the engine.

The temperature of the high power battery module is within the system default operating temperature range of the system battery, and the stored power of the high power battery module is lower than the system default power storage value of the high power battery power for starting the engine; then the low temperature battery module can provide power output to the high power battery module via the battery system power supply circuit, thereby charging the high power battery module; when the stored power of the high power battery module is increased to be higher than the system default power storage value of the high power battery for starting the engine; then the high power battery module can provide the power output to the power supply circuit connected with the vehicle, ship or mechanical equipment battery via the battery system power supply circuit for starting the engine.

The temperature of the high power battery module is lower than the system default battery operating temperature range and the temperature of the low temperature battery module is within the system default operating temperature range of the low temperature battery and higher than the heating start temperature of the low temperature battery; then the low temperature battery module can provide the power output to the heating plate 35 of the high power battery module via the battery system power supply circuit, thereby heating the high power battery module; after the temperature of the high power battery module is heated to the system default temperature range of the system battery and the stored power of the high power battery module is higher than the system default power storage value of the high power battery for starting the engine; then the high power battery module can provide power output to the power supply circuit connected with the vehicle, the ship or the mechanical equipment via the battery system power supply circuit in a low temperature environment, so as to start the engine.

The temperature of the high power battery module is lower than the system default battery operating temperature range, and the temperature of the low temperature battery module is within the system default temperature range and higher than the heating start temperature of the low temperature battery; then the low temperature battery module can provide the power output to the heating plates 35 of the high power battery module via the battery system power supply circuit, thereby heating the high power battery module; after the temperature of the high power battery module is heated to the system default temperature range of the system battery and the stored power of the high power battery module is lower than the system default power storage value of the high power battery for starting the engine; then the low temperature battery module can further provide the power output to the high power battery module via the battery system power supply circuit, thereby charging the high power battery module; after the stored power of the high power battery module is increased to be higher than the system default storage value of the high power battery power for starting the engine; then the high power battery module can provide the power output to the power supply circuit connected with the vehicle, the ship or the mechanical equipment via the battery system power supply circuit in a low temperature environment, so as to start the engine.

The temperature of the high power battery module is lower than the system default battery operating temperature range and the temperature of the low temperature battery module is within the system default operating temperature range of the low temperature battery but lower than the heating start temperature of the low temperature battery; then the low temperature battery module can provide the power output to the heating plate 35 of the low temperature battery module via the battery system power supply circuit, thereby heating the low temperature battery module; after the temperature of the low temperature battery module is heated to be higher than the system default heating start temperature of the low temperature battery; then the low temperature battery module can further provide the power output to the circuit plates 35 of the high power battery module via the battery system power supply circuit, thereby heating the high power battery module; after the temperature of the high power battery module is heated to be within the system default operating temperature range of the system battery and the stored power of the high power battery module is higher than the system default power storage value of the high power battery for starting the engine; then the high power battery module can provide the power output to the power supply circuit connected with vehicle, the ship or the mechanical equipment via the battery system power supply circuit in a low temperature environment, so as to start the engine.

The temperature of the high power battery module is lower than the system default battery operating temperature range and the temperature of the low temperature battery module is within the system default operating temperature range of the low temperature battery but lower than the heating start temperature of the low temperature battery; then the low temperature battery module can provide the power output to the heating plate 35 of the low temperature battery module via the battery system power supply circuit, thereby heating the low temperature battery module; after the temperature of the low temperature battery module is heated to be higher than the system default heating start temperature of the low temperature battery; then the low temperature battery module can further provide the power output to the heating plates 35 of the high power battery module via the battery system power supply circuit, thereby heating the high power battery module; after the temperature of the high power battery module is heated to be within the system default battery operating temperature range and the stored power of the high power battery module is lower than the system default power storage value of the high power battery for starting the engine; then the low temperature battery module can further provide the power output to the high power battery module via the battery system power supply circuit, thereby charging the high power battery module; after the stored power of the high power battery module is increased to be higher than the system default power storage value of the high power battery for starting the engine; then the high power battery module can provide the power output to the power supply circuit connected with vehicle, the ship or the mechanical equipment via the battery system power supply circuit in a low temperature environment, so as to start the engine.

The temperature of the low temperature battery module is lower than the system default operating temperature range of the low temperature battery; then the smart battery system does not work.

The external circuit charging mode includes the temperature of the main battery module of the smart battery system is within system default operating temperature range of the system battery; then the external power supply circuit can be electrically connected with the battery system power supply circuit, to provide the power input, and then charge the main battery module, the high power battery module and the low temperature battery module until the stored power is full.

The temperature of the main battery module of the smart battery system is lower than the system default operating temperature range of the system battery; then the external power supply circuit can provide the power input to the heating plates 35 electrically connected with the battery system power supply circuit, thereby heating the main battery module, the high power battery module and the low temperature battery module; after the temperature of the main battery module is heated to be within the system default operating temperature range of the system battery; then the external power supply circuit can further provide the power input electrically connected with the battery system power supply circuit, thereby charging the main battery module, the high power battery module and the low temperature battery module until the stored power is full.

The system battery of the smart battery system can be operated in 55° C.-5° C., the low temperature battery can be operated in 55° C.-30° C., and the heating start temperature of the low temperature battery is −10° C.

While the invention has been described in terms of preferred embodiments, those skilled in the art will recognize that the invention can be practiced with modifications within the spirit and scope of the appended claims.

What is claimed is:

1. A power supply method of starting an engine in a low temperature environment for a smart battery system including an outer casing, an upper cover disposed above the outer casing, and a body disposed inside the outer casing, comprising the steps of:
the temperature of the main battery module of the smart battery system is within the system default operating temperature range of the system battery and the stored power of the main battery module is higher than the default power storage value of the main battery used to start the engine;
the user can directly operate or control the start power switch of the vehicle, the ship or the mechanical equipment, and the main battery module of the smart battery system can provide the power output to the power supply circuit of the battery system connected with the vehicle, ship or mechanical equipment, so as to start the engine;
the temperature of the main battery module of the smart battery system is lower than the system default operating temperature range of the system battery, or the temperature of the main battery module is within the system default operating temperature range of the system battery, and the stored power of the main battery module is lower than the system default power storage value of the main battery for starting the engine;
the main battery module of the smart battery system cannot start the engine of the power supply circuit of the vehicle, the ship or the mechanical equipment electrically connected with the smart battery system, and the user can remotely control and set the smart battery system by the handheld control device, so that the system can enter the standby power supply mode to start the engine, or the user can control the setting of the smart battery system by directly pressing down the start switch of the upper cover of the smart battery system for setting the standby power supply mode of the smart battery system;
the standby power supply mode includes the temperature of the high power battery module is within a system default operating temperature range of the system battery, and the stored power of the high power battery module is higher than that of the high power battery for starting the engine; then the high power battery module can provide the power output to the power supply circuit connected with the vehicle, the ship or mechanical equipment via the battery system, so as to start the engine;
the temperature of the high power battery module is within the system default operating temperature range of the system battery, and the stored power of the high power battery module is lower than the system default power storage value of the high power battery power for starting the engine;
then the low temperature battery module can provide power output to the high power battery module via the battery system power supply circuit, thereby charging the high power battery module;
when the stored power of the high power battery module is increased to be higher than the system default power storage value of the high power battery for starting the engine;
then the high power battery module can provide the power output to the power supply circuit connected with the vehicle, ship or mechanical equipment battery via the battery system power supply circuit for starting the engine;
the temperature of the high power battery module is lower than the system default battery operating temperature range, and the temperature of the low temperature battery module is within the system default temperature range and higher than the heating start temperature of the low temperature battery;
then the low temperature battery module can provide the power output to the heating plates of the high power battery module via the battery system power supply circuit, thereby heating the high power battery module;
after the temperature of the high power battery module is heated to the system default temperature range of the system battery and the stored power of the high power battery module is lower than the system default power storage value of the high power battery for starting the engine;
then the low temperature battery module can further provide the power output to the high power battery module via the battery system power supply circuit, thereby charging the high power battery module;
after the stored power of the high power battery module is increased to be higher than the system default storage value of the high power battery power for starting the engine; then the high power battery module can provide the power output to the power supply circuit connected with the vehicle, the ship or the mechanical equipment via the battery system power supply circuit in a low temperature environment, so as to start the engine;
the temperature of the high power battery module is lower than the system default battery operating temperature range and the temperature of the low temperature battery module is within the system default operating temperature range of the low temperature battery but lower than the heating start temperature of the low temperature battery;
then the low temperature battery module can provide the power output to the heating plate of the low temperature battery module via the battery system power supply circuit, thereby heating the low temperature battery module;
after the temperature of the low temperature battery module is heated to be higher than the system default heating start temperature of the low temperature battery;
then the low temperature battery module can further provide the power output to the circuit plates of the high power battery module via the battery system power supply circuit, thereby heating the high power battery module;
after the temperature of the high power battery module is heated to be within the system default operating temperature range of the system battery and the stored power of the high power battery module is higher than the system default power storage value of the high power battery for starting the engine;
then the high power battery module can provide the power output to the power supply circuit connected with vehicle, the ship or the mechanical equipment via the battery system power supply circuit in a low temperature environment, so as to start the engine;
the temperature of the high power battery module is lower than the system default battery operating temperature range and the temperature of the low temperature battery module is within the system default operating temperature range of the low temperature battery but lower than the heating start temperature of the low temperature battery;
then the low temperature battery module can provide the power output to the heating plate of the low temperature battery module via the battery system power supply circuit, thereby heating the low temperature battery module;
after the temperature of the low temperature battery module is heated to be higher than the system default heating start temperature of the low temperature battery; then the low temperature battery module can further provide the power output to the heating plates of the high power battery module via the battery system power supply circuit, thereby heating the high power battery module;
after the temperature of the high power battery module is heated to be within the system default battery operating temperature range and the stored power of the high power battery module is lower than the system default power storage value of the high power battery for starting the engine;
then the low temperature battery module can further provide the power output to the high power battery module via the battery system power supply circuit, thereby charging the high power battery module;
after the stored power of the high power battery module is increased to be higher than the system default power storage value of the high power battery for starting the engine;
then the high power battery module can provide the power output to the power supply circuit connected with vehicle, the ship or the mechanical equipment via the battery system power supply circuit in a low temperature environment, so as to start the engine; and
the temperature of the low temperature battery module is lower than the system default operating temperature range of the low temperature battery; then the smart battery system does not work.

2. The power supply method of claim 1, wherein the user can electrically connect the external stable power supply circuit to the battery system power supply circuit via the DC voltage input port of the upper cover of the smart battery system by using the external transformer; the smart battery system will enter the external circuit charging mode, so as to directly charge the main battery module, the high power battery module and the low temperature battery module by using an indoor stable external power supply circuit; the external circuit charging mode includes the temperature of the main battery module of the smart battery system is within system default operating temperature range of the system battery; then the external power supply circuit can be electrically connected with the battery system power supply circuit, to provide the power input, and then charge the main battery module, the high power battery module and the low temperature battery module until the stored power is full; the temperature of the high power battery module is lower than the system default battery operating temperature range and the temperature of the low temperature battery module is within the system default operating temperature range of the low temperature battery and higher than the heating start temperature of the low temperature battery; then the low temperature battery module can provide the power output to the heating plate of the high power battery module via the battery system power supply circuit, thereby heating the high power battery module; after the temperature of the high power battery module is heated to the system default temperature range of the system battery and the stored power of the high power battery module is higher than the system default power storage value of the high power battery for starting the engine; then the high power battery module can provide power output to the power supply circuit connected with the vehicle, the ship or the mechanical equipment via the battery system power supply circuit in a low temperature environment, so as to start the engine; the temperature of the main battery module of the smart battery system is lower than the system default operating temperature range of the system battery; then the external power supply circuit can provide the power input to the heating plates electrically connected with the battery system power supply circuit, thereby heating the main battery module, the high power battery module and the low temperature battery module; after the temperature of the main battery module is heated to be within the system default operating temperature range of the system battery; then the external power supply circuit can further provide the power input electrically connected with the battery system power supply circuit, thereby charging the main battery module, the high power battery module and the low temperature battery module until the stored power is full.

3. The power supply method of claim 1, wherein the system battery of the smart battery system is operated in 55° C.-5° C., the low temperature battery is operated in 55° C.-30° C., and the heating start temperature of the low temperature battery is −10° C.

4. The power supply method of claim 2, wherein the system battery of the smart battery system is operated in 55° C.-5° C., the low temperature battery is operated in 55° C.-30° C., and the heating start temperature of the low temperature battery is −10° C.
